(19) United States
(12) Patent Application Publication
(10) Pub. No.: US 2021/0132704 A1
(43) Pub. Date: May 6, 2021

(54) SENSOR, INPUT DEVICE AND ELECTRONIC APPARATUS

(71) Applicant: Sony Corporation, Tokyo (JP)

(72) Inventors: Tomoki Kawabata, Kanagawa (JP); Hiroshi Mizuno, Kanagawa (JP); Ken Kobayashi, Kanagawa (JP); Akira Ebisui, Kanagawa (JP); Taizo Nishimura, Kanagawa (JP)

(73) Assignee: Sony Corporation, Tokyo (JP)

(21) Appl. No.: 16/488,744

(22) PCT Filed: Mar. 1, 2018
(86) PCT No.: PCT/JP2018/007836

§ 371 Date: Aug. 26, 2019

(30) Foreign Application Priority Data
Mar. 2, 2017 (JP) 2017-039747

(51) Int. Cl. G06F 3/0362; G06F 3/044

(52) U.S. Cl. CPC G06F 3/0362; G06F 3/0447

(57) ABSTRACT

A sensor includes: a sensor layer including a capacitive sensing section; and a metal layer facing a surface on one side of the sensor layer, in which the metal layer has projected portions provided at peripheral edges of regions facing the sensing sections.

### TECHNICAL FIELD

The present technology relates to a sensor, an input device and an electronic apparatus.

### BACKGROUND ART

As a capacitive pressure sensor, a sensor has been proposed which includes a variable film-shaped conductor layer, an electrode substrate having sensing sections, and a plurality of structures formed from a pressure sensitive adhesive resin material for spacing the conductor layer and the electrode substrate from each other, in which the structures are formed by a printing method (see, for example, PTL 1 and PTL 2). In this sensor, a change in the distance between the conductor layer and the electrode substrate when the conductor layer is pressed is detected by the sensing section, whereby the pressing position and the pressing force (pressure) are detected.

### CITATION LIST

### Patent Literature

[PTL 1]
JP 2014-179062A
[PTL 2]
WO 2014/147943

### SUMMARY

### Technical Problem

In the sensor having the above-mentioned configuration, since the structures are formed of a resin material, the structures are easily deformed, so that when the conductor layer is pressed, deformation of the conductor layer may occur in a range wider than the actual pressing position. If the conductor layer is varied in such a wide range, a change in capacitance would be detected at the sensing sections in a range wider than the actual pressing position.

It is an object of the present technology to provide a sensor, an input device and an electronic apparatus in which the range of deformation of a metal layer can be concentrated to a pressing position.

### Solution to Problem

In order to solve the aforementioned problem, according to a first technology, there is provided a sensor including: a sensor layer that includes a capacitive sensing section; and a metal layer facing a surface on one side of the sensor layer, in which the metal layer has a projected portion provided at a peripheral edge of a region facing the sensing section.

According to a second technology, there is provided an input device including: an armor; and a sensor provided at an inside surface of the armor, in which the sensor includes the sensor of the first technology.

According to a third technology, there is provided an input device including: a sensor layer that includes a capacitive sensing section; and a metal housing facing a surface on one side of the sensor layer, in which the metal housing has a projected portion provided at a peripheral edge of a region facing the sensing section.

According to a fourth technology, there is provided an electronic apparatus including: an armor; and a sensor provided at an inside surface of the armor, in which the sensor includes the sensor of the first technology.

According to a fifth technology, there is provided an electronic apparatus including: a sensor layer that includes a capacitive sensing section; and a metal housing facing a surface on one side of the sensor layer, in which the metal housing has a projected portion provided at a peripheral edge of a region facing the sensing section.

### Advantageous Effect of Invention

In accordance with the present technology, the range of deformation of the metal layer can be concentrated to the pressing position of the sensor. Note that the effect described here is not limitative, and any one of the effects described in the present disclosure or effects different from them may be embraced by the present technology.

### BRIEF DESCRIPTION OF DRAWINGS

FIG. 1 is an exploded perspective view depicting a configuration of an electronic apparatus according to a first embodiment of the present technology.

FIG. 2 is a perspective view depicting a shape of a sensor.

FIG. 3 is a sectional view depicting a configuration of the sensor.

FIG. 4 is a plan view depicting a configuration of a flexible printed circuit board.

FIG. 5 is a plan view depicting a configuration of a sensing section.

FIGS. 6A and 6B are perspective views depicting a configuration of a metal layer.

FIG. 7 is a block diagram depicting a circuit configuration of the electronic apparatus according to the first embodiment of the present technology.

FIG. 8 is a schematic figure for explaining each of regions of the electronic apparatus according to the first embodiment of the present technology.

FIG. 9 is a sectional view depicting a configuration of an electronic apparatus according to a modification of the first embodiment of the present technology.

FIGS. 10A and 10B are plan views depicting a shape and a layout of a structure provided at a sensing surface.

FIG. 11 is a sectional view depicting a modification of the electronic apparatus.

FIG. 12 is a sectional view depicting another modification of the electronic apparatus.

FIG. 13 is a sectional view depicting still another modification of the electronic apparatus.

FIG. 14 is a sectional view depicting yet another modification of the electronic apparatus.

FIG. 15 is a plan view depicting a configuration of an input device according to a second embodiment of the present technology.

FIG. 16 is a sectional view taken along line XVI-XVI of FIG. 15.

FIG. 17 is a perspective view depicting a configuration of a metal layer.

FIGS. 18A and 18B are sectional views depicting a modification of the input device.

FIG. 19A is a plan view depicting a configuration of an input device according to a third embodiment of the present technology. FIG. 19B is a sectional view taken along line XIXB-XIXB of FIG. 19A.

FIG. 20 is a plan view depicting a configuration of a metal layer.

FIGS. 21A and 21B are plan views depicting a modification of the metal layer.

FIGS. 22A and 22B are plan views depicting a modification of the metal layer.

FIG. 23A is a sectional view depicting a configuration of an input device according to a modification of the third embodiment of the present technology. FIG. 23B is a plan view depicting a configuration of a metal layer possessed by the input device illustrated in FIG. 23A.

FIG. 24 is a sectional view depicting a configuration of an electronic apparatus according to the third embodiment of the present technology.

### DESCRIPTION OF EMBODIMENTS

Embodiments of the present technology will be described in the following order.

1 First Embodiment (Example of electronic apparatus)

2 Second Embodiment (Example of input device)

3 Third Embodiment (Example of input device)

4 Fourth Embodiment (Example of electronic apparatus)

### 1 First Embodiment

### Configuration of Electronic Apparatus

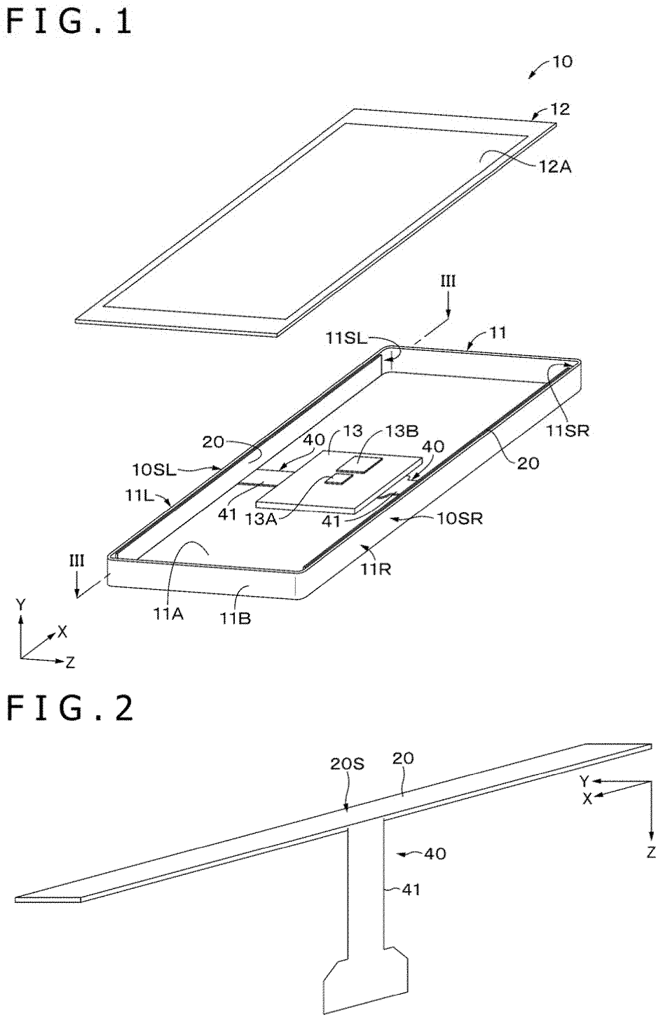

An electronic apparatus 10 according to a first embodiment of the present technology is a so-called smartphone, which includes a housing 11 as an armor, two sensors 20, 20, a front panel 12, and a substrate 13, as depicted in FIG. 1. The substrate 13 and the sensors 20 are connected by connection sections 41, and are accommodated in the housing 11. Of the housing 11, a main surface on one side is open, while a main surface on the other side is closed. The open main surface on one side of the housing 11 is closed by the front panel 12.

The electronic apparatus 10 is configured such that the electronic apparatus 10 can be operated by pressing its side surfaces 10SR and 10SL with a hand or a finger. The housing 11 and the two sensors 20, 20 constitute an input device. The input device may further include the substrate 13, as required.

(Housing)

The housing 11 includes a rectangular main surface section 11A constituting a back surface of the electronic apparatus 10, and a wall section 11B provided at peripheral edges of the main surface section 11A. The wall section 11B is raised perpendicularly to the main surface section 11A. The wall section 11B includes side wall sections 11R and 11L provided on both long edge sides of a main surface section 11M. The sensors 20, 20 are provided respectively at inside surfaces 11SL and 11SR of the side wall sections 11R and 11L.

The housing 11 includes, for example, a metal, a polymer resin, wood or the like. Examples of the metal include simple substances such as aluminum, titanium, zinc, nickel, magnesium, copper and iron, and alloys containing two or more of them. Examples of the alloys include stainless steel (Stainless Used Steel: SUS), aluminum alloys, magnesium alloys, or titanium alloys. Examples of the polymer resin include a copolymer synthetic resin of acrylonitrile, butadiene and styrene (ABS resin), polycarbonate (PC) resins, or PC-ABS alloy resins.

(Substrate)

The substrate 13 is a main substrate of the electronic apparatus 10, and includes a controller IC (Integrated Circuit) (hereinafter referred to simply as “IC”) 13A, and a main CPU (Central Processing Unit) (hereinafter referred to simply as “CPU”) 13B. The IC 13A is a control section that controls the two sensors 20, 20 and detects pressures exerted on the sensors 20, 20. The CPU 13B is a control section that controls the electronic apparatus 10 as a whole. For instance, the CPU 13B performs various kinds of processing, based on signals supplied from the IC 13A.

(Front Panel)

The front panel 12 includes a display 12A, and a capacitive touch panel is provided on a surface of the display 12A. The display 12A displays a video image (screen), based on, for example, a video signal supplied from the CPU 13B. Examples of the display 12A include a liquid crystal display and an EL (Electro Luminescence) display, which are not limitative.

(Sensor)

As illustrated in FIG. 2, the sensor 20 has an elongate rectangular shape, and the connection section 41 extends from a center of a long side of the sensor 20. The sensor 20 may be plate-like or film-like in shape. Note that herein the film includes a sheet. A main surface on one side of the sensor 20 is a sensing surface 20S for detection of pressing.

The sensor 20 and the connection section 41 are integrally configured by a T-shaped flexible printed circuit (hereinafter referred to as “FPC”) 40. With such a configuration adopted, the number of component parts can be reduced. In addition, shock resistance of connection between the sensor 20 and the substrate 13 can be enhanced. It is to be noted, however, that the sensor 20 and the connection section 41 may be configured as separate bodies. In this configuration, the sensor 20 may be configured using a rigid substrate or a rigid flexible substrate.

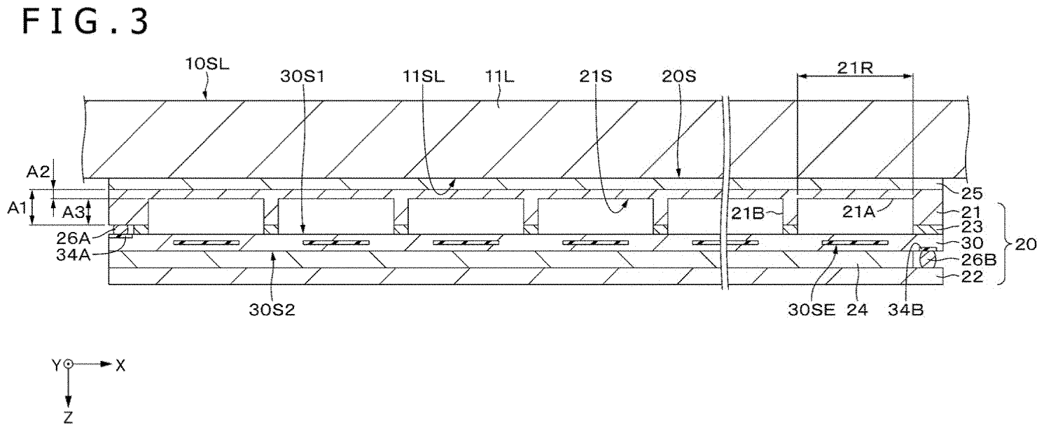

The sensor 20 is a so-called capacitive pressure sensor. As depicted in FIG. 3, the sensor 20 includes: a mutual capacitive sensor layer 30 that has a first main surface 30S1 and a second main surface 30S2 and includes a plurality of capacitive sensing sections 30SE; a metal layer 21 facing the first main surface 30S1 of the sensor layer 30; and a conductive layer 22 facing the second main surface 30S2 of the sensor layer 30. The sensing surfaces 20S of the sensors 20 are adhered to the side wall sections 11R and 11L through adhesive layers 25, respectively. Note that herein a longitudinal direction of the rectangular sensing surface 20S which is not pressed and is in a flat surface state is referred to as an X-axis direction, a transverse direction (short side direction) of the sensing surface 20S is referred to as a Y-axis direction, and a direction perpendicular to the sensing surface 20S is referred to as a Z-axis direction.

The metal layer 21 and the sensor layer 30 are disposed such that their main surfaces face each other. The metal layer 21 and the sensor layer 30 are adhered to each other by an adhesive layer 23. The conductive layer 22 and the sensor layer 30 are disposed such that their main surfaces face each other. The conductive layer 22 and the sensor layer 30 are adhered to each other by an adhesive layer 24. The metal layer 21 is connected to a grounding electrode 34A provided at one end of the first main surface 30S1 of the sensor layer 30, through a connection member 26A such as an ACF (Anisotropic Conductive Film), and the conductive layer 22 is connected to a grounding electrode 34B provided at the other end of the second main surface 30S2 of the sensor layer 30, through a connection member 26B such as an ACF.

(Sensor Layer)

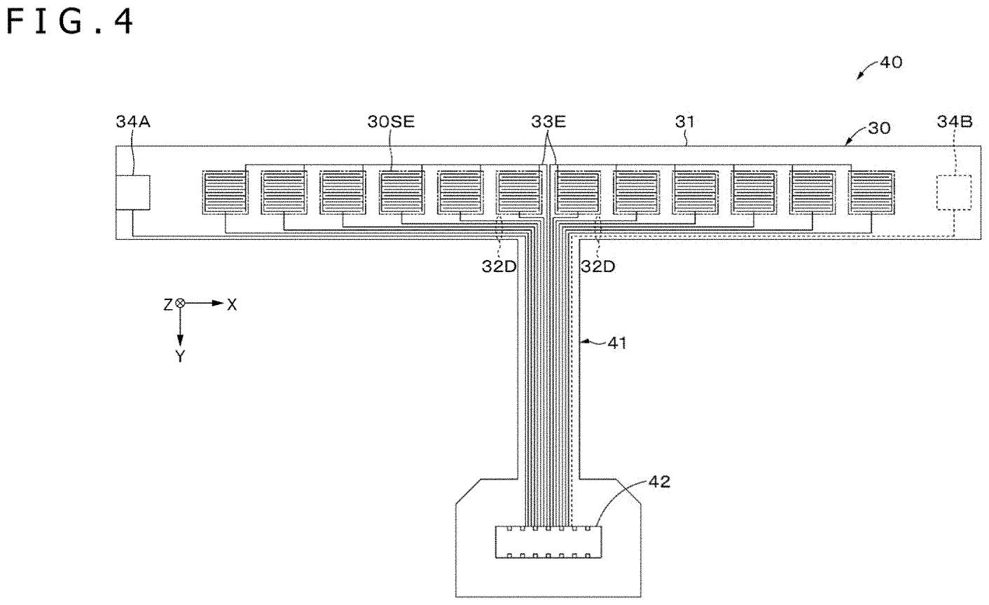

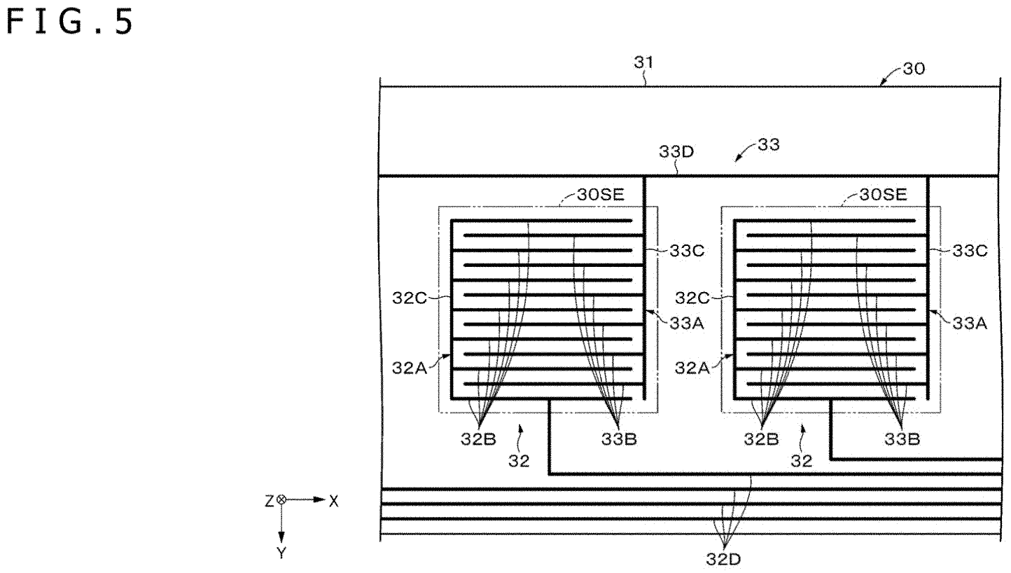

As depicted in FIGS. 4 and 5, the sensor layer 30 includes a plurality of pulse electrodes 32, one sense electrode 33 and one grounding electrode 34A which are provided on a main surface on one side of a part extending in the X-axis direction, of a flexible T-shaped base material 31, and one grounding electrode 34B which is provided on a main surface on the other side of the part extending in the X-axis direction. The pulse electrode 32 and the sense electrode 33 constitute the sensing section 30SE. In plan view of the plurality of sensing sections 30SE along the Z-axis direction, the plurality of sensing sections 30SE is disposed one-dimensionally so as to be in line at regular intervals in the X-axis direction (the longitudinal direction of the sensor layer 30). Note that the pulse electrode 32 and the sense electrode 33 are not limited to those in the above configuration, and the configurations of the pulse electrode 32 and the sense electrode 33 may be replaced by each other.

The connection section 41 includes wirings 32D and 33E and a connection terminal 42 which are provided on a main surface on one side of a part extending in the Z-axis direction, of the T-shaped base material 31. The wiring 32D electrically connects the pulse electrode 32 and the grounding electrodes 34A and 34B of the sensor layer 30 to a connection terminal 42 provided at a tip of the connection section 41. The wiring 33E electrically connects the sense electrode 33 of the sensor layer 30 to the connection terminal 42 provided at the tip of the connection section 41. The connection terminal 42 is electrically connected to the substrate 13.

The FPC 40 may further include, on a main surface on one side of the base material 31, an insulation layer (not illustrated) such as a cover lay film that covers the pulse electrode 32, the sense electrode 33 and the wirings 32D and 33E.

The base material 31 is a substrate or film that contains a polymer resin and is flexible. The polymer resin contains at least one selected from among polyethylene terephthalate (PET), polyethylene naphthalate (PEN), polycarbonate (PC), acrylic resin (PMMA), polyimide (PI), triacetyl cellulose (TAC), polyester, polyamide (PA), aramid, polyethylene (PE), polyacrylate, polyether-sulfone, polysulfone, polypropylene (PP), diacetyl cellulose, polyvinyl chloride, epoxy resin, urea resin, urethane resin, melamine resin, cyclic olefin polymer (COP) and norbornene thermoplastic resins.

As depicted in FIG. 5, the pulse electrode 32 as a first electrode includes one unit electrode body 32A. The unit electrode bodies 32A possessed respectively by the plurality of pulse electrodes 32 are one-dimensionally disposed in a line at regular intervals in the X-axis direction. As illustrated in FIG. 5, the sense electrode 33 as a second electrode includes a plurality of unit electrode bodies 33A and one connection section 33D. The plurality of unit electrode bodies 33A is one-dimensionally disposed in a line at regular intervals in the X-axis direction, and the adjacent unit electrode bodies 33A are connected by the connection section 33D.

The wiring 32D is led out from the pulse electrode 32, is led around to a peripheral edge portion of one main surface of the base material 31, and is connected to the connection terminal 42 through the connection section 41. The wiring 33E is led out from the sense electrode 33, is led around to a peripheral edge portion of one main surface of the base material 31, and is connected to the connection terminal 42 through the connection section 41.

The unit electrode bodies 32A and 33A are comb tooth-shaped, and are disposed with their comb tooth parts meshed with each other. Specifically, the unit electrode body 32A includes a plurality of linearly shaped sub-electrodes 32B, and a linearly shaped connection part 32C. The unit electrode body 33A includes a plurality of linearly shaped sub-electrodes 33B, and a linearly shaped connection part 33C. The pluralities of sub-electrodes 32B and 33B extend in the X-axis direction, and are alternately spaced at predetermined intervals in the Y-axis direction. The adjacent sub-electrodes 32B and 33B are configured to be able to form capacitive coupling.

The connection part 32C extends in the Y-axis direction, and interconnects one-side ends of the plurality of sub-electrodes 32B. The connection part 33C extends in the Y-axis direction, and interconnects other-side ends of the plurality of sub-electrodes 33B. The intervals of the sub-electrodes 32B and 33B may be fixed or may vary. The unit electrode bodies 32A and 33A disposed in a mutually meshed manner constitute the sensing section 30SE.

(Metal Layer)

The metal layer 21 has an elongate film-like shape. The metal layer 21 has projected portions 21B provided at peripheral edges of regions 21R facing the sensing sections 30SE. Specifically, the metal layer 21 has a projected and recessed surface 21S facing the first main surface 30S1 of the sensor layer 30, and recessed portions 21A of the projected and recessed surface 21S are provided correspondingly to the sensing sections 30SE, whereas the projected portions 21B of the projected and recessed surface 21S are provided correspondingly to the spaces between the adjacent sensing sections 30SE. More specifically, the recessed portions 21A of the projected and recessed surface 21S are provided such that the center positions of the recessed portions 21A and the sensing sections 30SE overlap with each other in the thickness direction of the sensor 20 (Z-axis direction), whereas the projected portions 21B of the projected and recessed surface 21S are provided so as to overlap with intermediate positions between the adjacent sensing sections 30SE in the thickness direction of the sensor 20 (Z-axis direction). Tips of the projected portions 21B and the sensor layer 30 are adhered to each other by adhesive layers 23, respectively.

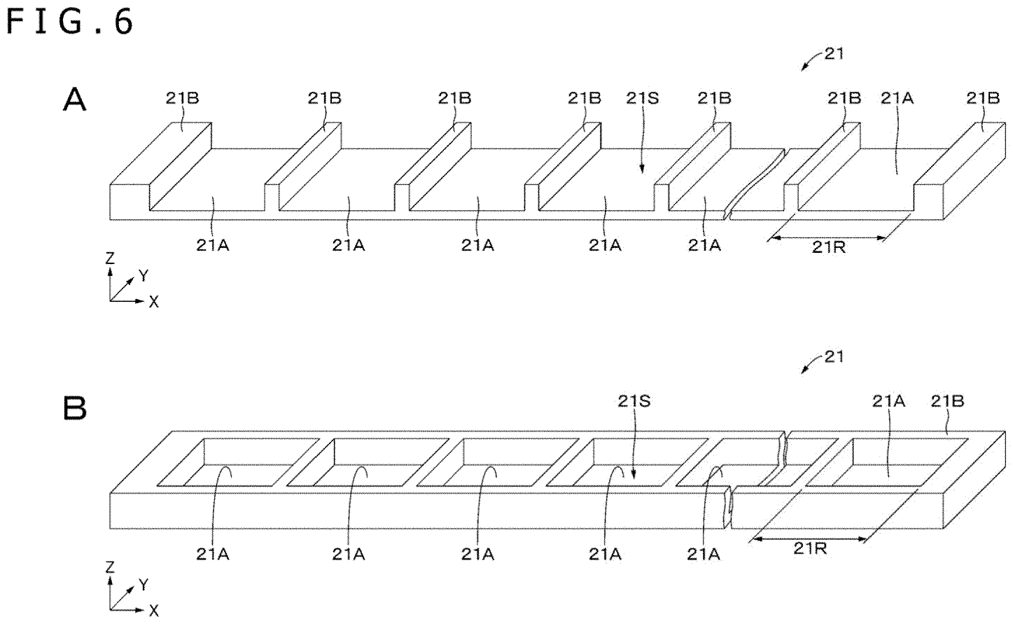

The projected portions 21B are preferably provided so as to divide the adjacent regions 21R. Specifically, as depicted in FIG. 6A, the projected portions 21B are preferably provided periodically in the longitudinal direction of the metal layer 21. In this case, in plan view of the projected portions 21B as viewed in the direction perpendicular to the projected and recessed surface 21S (Z-axis direction), the projected portions 21B have an elongate rectangular shape extending in the width direction of the metal layer 21. Note that the shape of the projected portions 21B is not limited to the just-mentioned, but may be a truncated cone or pyramid, a cube or a hemisphere. When such a shape is adopted, a plurality of the projected portions 21B may be provided while aligned in the width direction of the metal layer 21.

The projected portions 21B may be provided so as to surround each of the regions 21R, and the regions 21R may be hollows. Specifically, as illustrated in FIG. 6B, recessed portions 21A each surrounded by the projected portions 21B on four sides may be provided periodically in the longitudinal direction of the metal layer 21. In plan view of the recessed portions 21A in the direction perpendicular to the projected and recessed surface 21S (Z-axis direction), the recessed portions 21A have a tetragonal shape. Note that the shape of the recessed portions 21A in plan view as viewed in the direction perpendicular to the projected and recessed surface 21S is not limited to the just-mentioned, but may be a circle, an ellipse, a polygon other than a tetragon, an oval or elliptic shape, an irregular shape or the like.

Those parts of the metal layer 21 which correspond to the regions 21R are flexible. Specifically, those parts of the metal layer 21 which correspond to the regions 21R are configured to be deformable toward the sensor layer 30 by pressing of the metal layer 21. The projected portions 21B has a function of restricting the deformation of the metal layer 21 to within the region 21R. Bottom surfaces of the regions 21R, or of the recessed portions 21A, may be flat surfaces or may be curved surfaces.

A total thickness A1 of the metal layer 21 is, for example, 30 μm to 1 mm. The thickness A2 of bottoms of the recessed portions 21A is, for example, 10 to 100 μm, and the depth A3 of the recessed portions 21A is, for example, 20 to 900 μm.

Examples of the metal constituting the metal layer 21 include simple substances such as aluminum, titanium, zinc, nickel, magnesium, copper and iron, and alloys containing two or more of them. Specific examples of the alloys include stainless steel (Stainless Used Steel: SUS), aluminum alloys, magnesium alloys, and titanium alloys.

The projected and recessed surface 21S is formed by processing a surface of the metal layer 21. As a direction for surface processing, etching (half etching) is preferably used. With the projected portions 21B as columnar bodies set thinner or smaller, the regions 21R can be secured to be wider. In other words, the deformation of the regions 21R at the time of pressing can be enlarged, and, therefore, sensitivity of the sensor 20 can be enhanced. In the case where etching is used as a direction for surface processing, the projected and recessed surface (etched surface) 21S tends to have a relatively large variability in thickness. For instance, while the variability in the thickness of the metal layer 21, or in the total thickness A1 (see FIG. 3) before etching is not more than 10%, the variability of the thickness of the bottom surfaces of the recessed portions 21A of the metal layer 21 after etching is not less than 20%.

(Conductive Layer)

Examples of the shape of the conductive layer 22 include a thin film-like shape, a foil-like shape, and a mesh-like shape, which are not limitative. The conductive layer 22 need only be electrically conductive; for example, an inorganic conductive layer containing an inorganic conductive material, an organic conductive layer containing an organic conductive material, an organic-inorganic conductive layer containing both an inorganic conductive material and an organic conductive material, and the like can be used as the conductive layer 22. The inorganic conductive material and the organic conductive material may be in the form of particles.

Examples of the inorganic conductive material include metals and metallic oxides. Here, it is defined that the metals include semimetals. Examples of the metals include metals such as aluminum, copper, silver, gold, platinum, palladium, nickel, tin, cobalt, rhodium, iridium, iron, ruthenium, osmium, manganese, molybdenum, tungsten, niobium, tantalum, titanium, bismuth, antimony and lead, or alloys thereof, which are not limitative. As the alloy, stainless steel (Stainless Used Steel: SUS) is preferable. Examples of the metallic oxides include indium tin oxide (ITO), zinc oxide, indium oxide, antimony-added tin oxide, fluorine-added tin oxide, aluminum-added zinc oxide, gallium-added zinc oxide, silicon-added zinc oxide, zinc oxide-tin oxide-based material, indium oxide-tin oxide-based material, and zinc oxide-indium oxide-magnesium oxide-based material, which are not restrictive.

Examples of the organic conductive material include carbon materials and conductive polymers. Examples of the carbon materials include carbon black, carbon fiber, fullerene, graphene, carbon nanotube, carbon microcoil, and nanohorn, which are not limitative. Examples of the conductive polymers include substituted or unsubstituted polyaniline, polypyrrole, polythiophene, and (co)polymers containing one or two selected from among them, which are not limitative.

(Adhesive Layer)

The adhesive layers 23, 24 and 25 contain an adhesive. As the adhesive, there can be used, for example, at least one selected from the group consisting of acrylic adhesives, silicone adhesives, urethane adhesives and the like. Here, it is defined that pressure sensitive adhesion is a kind of adhesion. According to this definition, a pressure sensitive adhesive layer is deemed as a kind of adhesive layer. The adhesive layers 23, 24 and 25 may each be composed of a double-faced adhesive film.

The adhesive layer 24 may have a function as a deformation layer, for adjusting the sensitivity of the sensor 20. Specifically, upon pressing of the sensing surface 20S, the adhesive layer 24 may be elastically deformed, with the result of a change in the distance between the sensor layer 30 and the conductive layer 22.

### Circuit Configuration of Electronic Apparatus

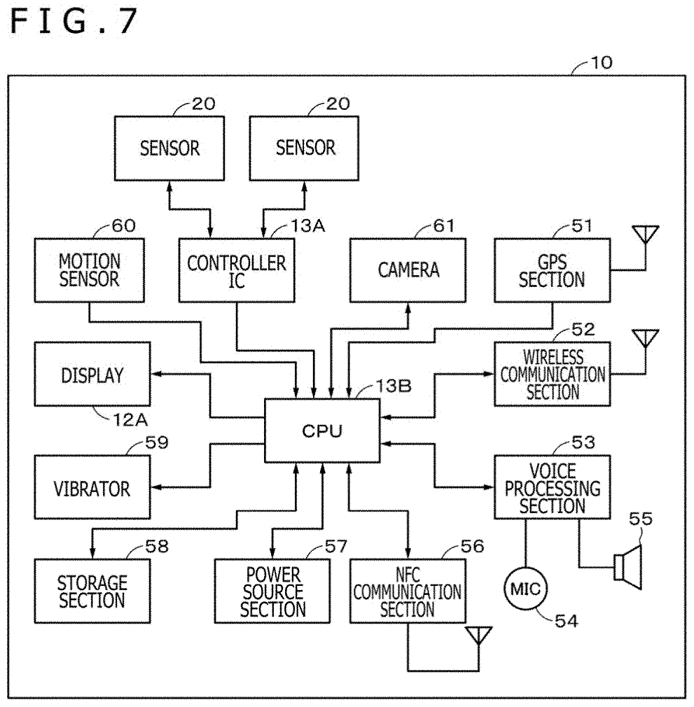

As depicted in FIG. 7, the electronic apparatus 10 include the two sensors 20, the CPU 13B, the IC 13A, a GPS section 51, a wireless communication section 52, a voice processing section 53, a microphone 54, a speaker 55, an NFC communication section 56, a power source section 57, a storage section 58, a vibrator 59, a display 12A, a motion sensor 60, and a camera 61.

The GPS section 51 is a positioning section for positioning the current position by receiving electromagnetic waves from satellites of a system called GPS (Global Positioning System). The wireless communication section 52 performs short range wireless communication with other terminals by the standard of Bluetooth (registered trademark), for example. The NFC communication section 56 performs wireless communication with a proximate reader/writer by the standard of NFC (Near Field Communication). Data obtained by the GPS section 51, the wireless communication section 52 and the NFC communication section 56 are supplied to the CPU 13B.

The microphone 54 and the speaker 55 are connected to the voice processing section 53. The voice processing section 53 processes a call with a person connected by wireless communication by the wireless communication section 52. In addition, the voice processing section 53 can also perform processing for a voice input operation.

The power source section 57 supplies electric power to the CPU 13B, the display 12A and the like possessed by the electronic apparatus 10. The power source section 57 includes a secondary battery such as a lithium ion secondary battery, and a charge-discharge control circuit for controlling charging and discharging of the secondary battery. Note that though not depicted in FIG. 7, the electronic apparatus 10 includes a terminal for charging the secondary battery.

The storage section 58 is a ROM (Read Only Memory), a RAM (Random Access Memory), and the like, and stores various kinds of data such as an OS (Operating System), applications, moving images, images, music and documents.

The vibrator 59 is a member for vibrating the electronic apparatus 10. For example, the electronic apparatus 10 vibrates the electronic apparatus 10 by the vibrator 59, so as to inform reception of a telephone call, reception of an electronic mail, or the like.

The display 12A displays various kinds of screens, based on, for example, a video signal supplied from the CPU 13B. In addition, a signal according to a touch operation on a display surface of the display 12A is supplied to the CPU 13B.

The motion sensor 60 detects a motion of a user holding the electronic apparatus 10. As the motion sensor 60, there is used an acceleration sensor, a gyro sensor, an electronic compass, an air pressure sensor or the like.

The camera 61 includes a group of lenses and an imaging element such as a CMOS (Complementary Metal Oxide Semiconductor), and picks up an image such as a still image or a moving image, based on control of the CPU 13B. The still image, moving image or the like picked up is stored in the storage section 58.

The sensor 20 is a pressure sensor high in sensitivity and high in position resolution, detects a capacitance according to a pressing operation corresponding to the sensing surface 20S, and outputs an output signal according to the detected capacitance to the IC 13A.

The IC 13A stores a firmware for controlling the sensors 20, detects variations (pressure) in capacitance of each of sensing sections 30SE possessed by the sensors 20, and outputs a signal according to the detection results to the CPU 13B.

The CPU 13B performs various kinds of processing, based on the signal supplied from the IC 13A. In addition, the CPU 13B processes data supplied from the GPS section 51, the wireless communication section 52, the NFC communication section 56, the motion sensor 60 and the like.

### Each Region of Electronic Apparatus

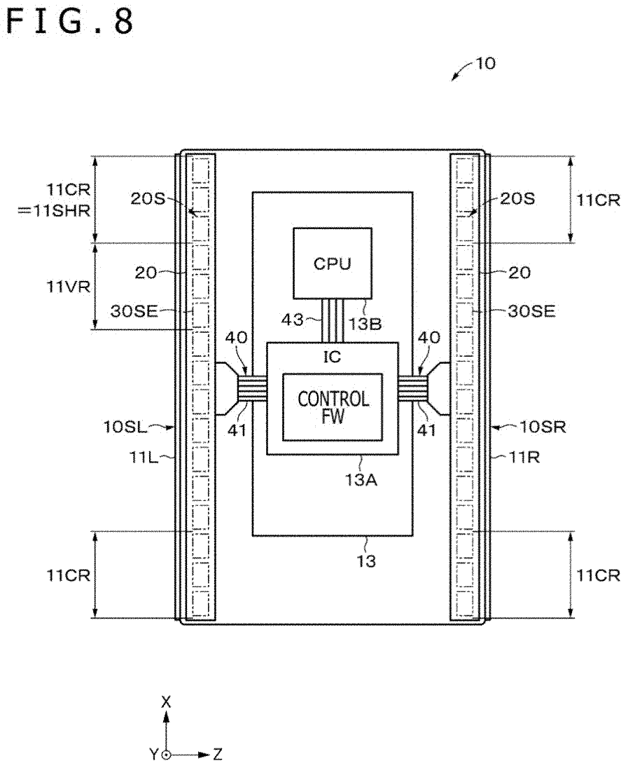

As depicted in FIG. 8, the sensors 20 are each connected to the IC 13A through the connection section 41. The IC 13A and the CPU 13B are connected to each other by a bus such as I²C. While a configuration in which the sensor 20 has sixteen sensing sections 30SE is depicted in FIG. 8, the number of the sensing sections 30SE is not limited to this, but can be appropriately set according to the characteristics of the sensor 20 desired. In addition, while the sensing surface 20S is illustrated to be parallel to an XZ plane for easier understanding of the configuration of the sensor 20, the sensing surface 20S, in practice, is maintained in parallel to an XY plane.

(Sound Volume Adjustment Region)

The electronic apparatus 10 has at a side surface 10SR a sound volume adjustment region 11VR for adjusting sound volume. When the sound volume adjusting region 11VR is slid in an upward direction (first direction) by a finger, sound volume can be thereby raised, and when the sound volume adjustment region 11VR is slid in a downward direction (second direction) by a finger, the sound volume can be thereby lowered. Here, the upward direction means a +X-axis direction, and the downward direction means a −X-axis direction.

Note that the sound volume adjustment region 11VR is an example of a slide operation region. In addition, the position of the sound volume adjustment region 11VR depicted in FIG. 8 is an example, and the position of the sound volume adjustment region 11VR is not limited to this. Besides, while a configuration in which the electronic apparatus 10 includes the sound volume adjustment region 11VR only at the side surface 10SL is illustrated in FIG. 8, the sound volume adjustment regions 11VR may be provided at both the side surfaces 10SR and 10SL.

The sound volume adjustment region 11VR has two or more sensing sections 30SE. The IC 13A determines whether an upward or downward sliding operation has been applied to the sound volume adjustment region 11VR, based on signals from the sensing sections 30SE possessed by the sound volume adjustment region 11VR. In the case where it is determined that an upward or downward sliding operation has been performed, the IC 13A supplies the CPU 13B with a signal for informing that the upward or downward sliding operation has been made.

(Camera Holding Region)

The electronic apparatus 10 has camera holding regions 11CR at both ends of each of the side surfaces 10SR and 10SL. When the user holds the four camera holding regions 11CR with fingers, a camera application starts automatically. The camera holding region 11CR has at least one sensing section 30SE.

The IC 13A determines whether or not the user is holding the four camera holding regions 11CR with fingers, based on signals supplied from the sensing sections 30SE possessed by each camera holding region 11CR. In the case where it is determined that the four camera holding regions 11CR are held by the user's fingers, the IC 13A supplies the CPU 13B with a signal demanding starting of the camera application.

(Shutter Operation Region)

The electronic apparatus 10 has a shutter operation region 11SHR at one end portion in an upward direction of the side surface 10SL. Note that while a configuration in which the shutter operation region 11SHR and one of the four camera holding regions 11CR are the same region is depicted in FIG. 8, these regions may be different regions.

The IC 13A determines whether or not the shutter operation region 11SHR is being pressed by a finger, based on a signal supplied from the sensing section 30SE possessed by the shutter operation region 11SHR. In the case where it is determined that the shutter operation region 11SHR is being held by a finger, the IC 13A supplies the CPU 13B with a signal demanding a shutter operation (or an image picking-up operation).

### Operation of Sensor

An operation of the sensor 20 according to the first embodiment of the present technology will be described below. When the IC 13A impresses a voltage between the pulse electrode 32 and the sense electrode 33, specifically, between the sub-electrodes 32B and 33B, an electric line of force (capacitive coupling) is formed between the sub-electrodes 32B and 33B.

When the sensing surface 20S of the sensor 20 is pressed, the region 21R of the metal layer 21 (or the bottom of the recessed portion 21A) is bent toward the sensor layer 30. As a result, the region 21R of the metal layer 21 and the sensing section 30SE approach each other, and part of the electric line of force between the sub-electrodes 32B and 33B flows into the region 21R of the metal layer 21, resulting in a change in the capacitance of the sensing section 30SE. Based on the change in the capacitance, the IC 13A detects the pressure exerted on one main surface of the sensor 20, and outputs the detection result to the CPU 13B.

### Effect

The sensor 20 according to the first embodiment includes the sensor layer 30 including the capacitive sensing sections 30SE, and the metal layer 21 facing a surface on one side of the sensor layer 30, and the metal layer 21 has the projected portions 21B provided at peripheral edges of the regions 21R facing the sensing sections 30SE. As a result, the adjacent sensing sections 20SE can be divided from each other by the projected portion 21B which is high in rigidity. Therefore, deformation of the projected portions 21B when the sensing surface 20S is pressed is restrained, and, accordingly, the deformation range of the metal layer 21 can be concentrated into the actual position where the sensor 20 is pressed. Therefore, detection of the change in capacitance by the sensing sections 30SE in a range wider than the actual pressing position can be restrained. In other words, detection accuracy of the sensor 20 can be enhanced.

In the sensor 20 according to the first embodiment, the projected portions 21B formed of a metal can be formed by etching, and, therefore, the projected portions 21B can be set thinner (smaller in diametric size) or smaller. Accordingly, the area of the region 21R (or the bottom of the recessed portion 21A) deformed upon pressing can be broadened. On the other hand, in the sensors of PTL 1 and PTL 2, the structure formed of a resin material is formed by a printing method or the like, and, therefore, it is difficult to make the structure thinner or smaller.

In the electronic apparatus 10 according to the first embodiment, the sensors 20, 20 are provided respectively at the inside surfaces 11SL and 11SR of the side wall sections 11R and 11L. Therefore, the electronic apparatus 10 can be operated by pressing the side surfaces 10SR and 10SL of the electronic apparatus 10 with a hand or finger. In addition, since detection of a change in capacitance at the sensing sections 30SE in a range wider than the actual pressing position of the side surface 10SR, 10SL can be restrained as aforementioned, malfunction of the electronic apparatus 10 can be restrained.

### Modifications

### Modification 1

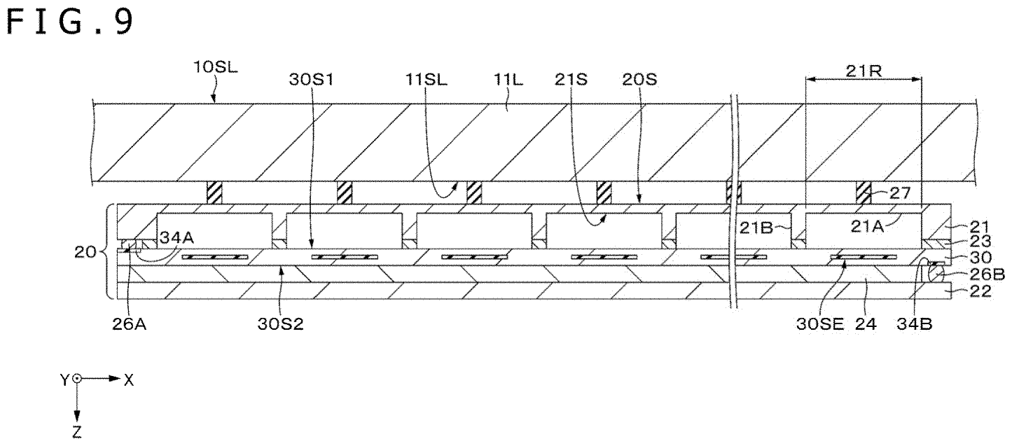

As illustrated in FIG. 9, the electronic apparatus 10 may further include a plurality of structures 27 between the metal layer 21 and the side wall section 11L. Note that though not illustrated, the electronic apparatus 10 may further include a plurality of structures 27 also between the metal layer 21 and the side wall section 11R.

The structures 27 are provided at positions corresponding to the sensing sections 30SE. Specifically, the structures 27 are provided so as to overlap with the sensing sections 30SE in the thickness direction of the sensor 20. The structure 27 includes, for example, a resin material or a metallic material.

The structures 27 may be projected portions provided at a surface (namely, the sensing surface 20S) on the side opposite to the projected and recessed surface 21S, of the metal layer 21. In this case, the projected portions may be formed by a method in which the surface on the side opposite to the projected and recessed surface 21S, of the metal layer 21, is subjected to projection/recess processing such as etching, or a method in which a resin material is applied by printing to the surface on the side opposite to the projected and recessed surface 21S, of the metal layer 21, or a method in which a resin piece such as a single-faced or double-faced pressure sensitive adhesive film is adhered to the just-mentioned surface.

In addition, the structures 27 may be projected portions provided at the inside surface 11SL of the side wall section 11L. In this case, the projected portions may be formed by a method in which the inside surface 11SR is subjected to projection/recess processing such as etching, or a method in which a resin material is applied by printing to the inside surface 11SR, or a method in which a resin piece such as a single-faced or double-faced pressure sensitive adhesive film is adhered to the inside surface 11SR.

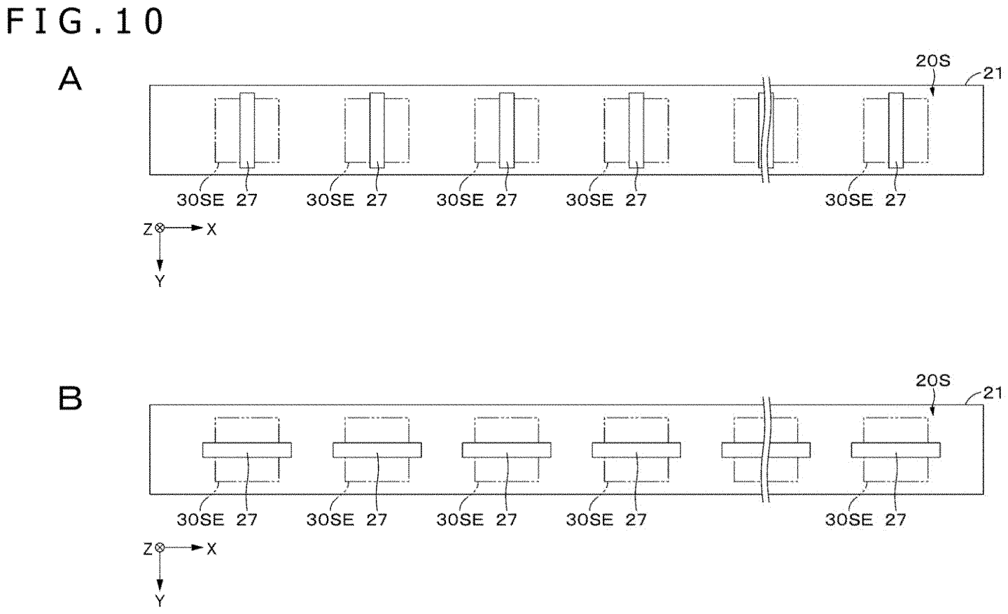

The structures 27 may have an elongate rectangular shape extending in the width direction of the metal layer 21, and may be provided periodically in the longitudinal direction of the metal layer 21, when viewed in the direction perpendicular to the sensing surface 20S (−Z-axis direction), as depicted in FIG. 10A.

Besides, the structures 27 may have an elongate rectangular shape extending in the longitudinal direction of the metal layer 21, and may be provided periodically in the longitudinal direction of the metal layer 21, when viewed in the direction perpendicular to the sensing surface 20S (−Z-axis direction), as illustrated in FIG. 10B.

Note that the shape of the structures 27 is not limited to the above-mentioned shapes, but may be a truncated cone or pyramid, a cube, a hemisphere or the like. In addition, a plurality of structures 27 may be provided for one sensing section 30SE.

### Modification 2

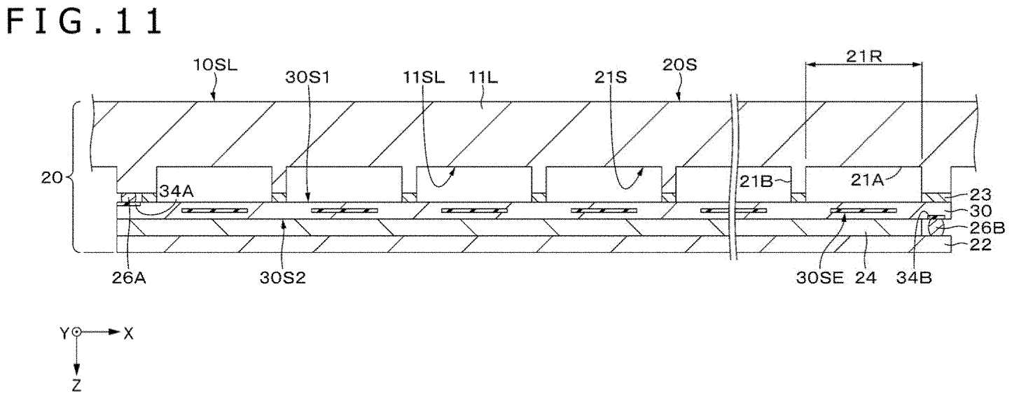

As depicted in FIG. 11, the sensor 20 may not include the metal layer 21, and the inside surface 11SL of the side wall section 11L may be a projected and recessed surface similar to the projected and recessed surface 21S of the metal layer 21. In this case, the housing 11 is a metallic housing. The projected and recessed surface is preferably formed by subjecting the inside surface 11SL of the side wall section 11L to projection/recess processing such as etching.

### Modification 3

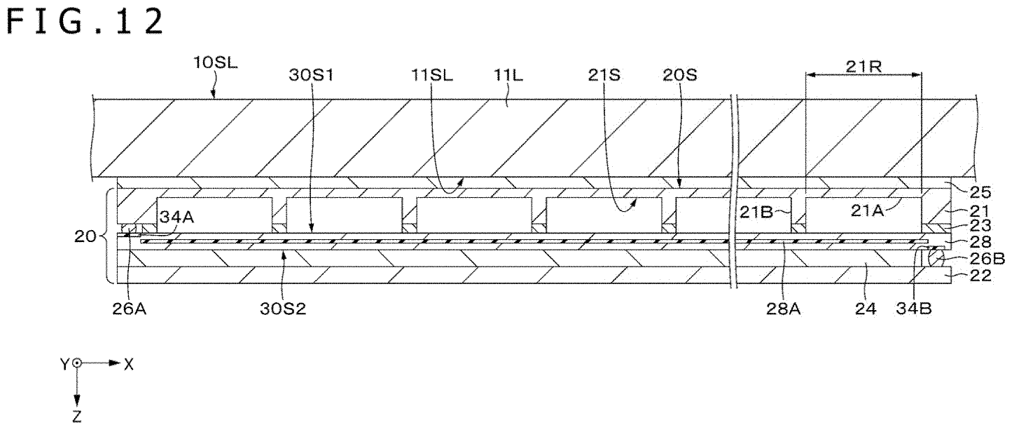

While a case where the sensor 20 has the mutual capacitive sensor layer 30 has been described in the first embodiment, the sensor 20 may have a self-capacitive sensor layer 28, as illustrated in FIG. 12. Specifically, the sensor 20 may include the sensor layer 28 having a thin plate-shaped electrode 28A, and the electrode 28A may spread in plane directions of the sensor layer 28 over substantially the whole area of the sensor layer 28.

### Modification 4

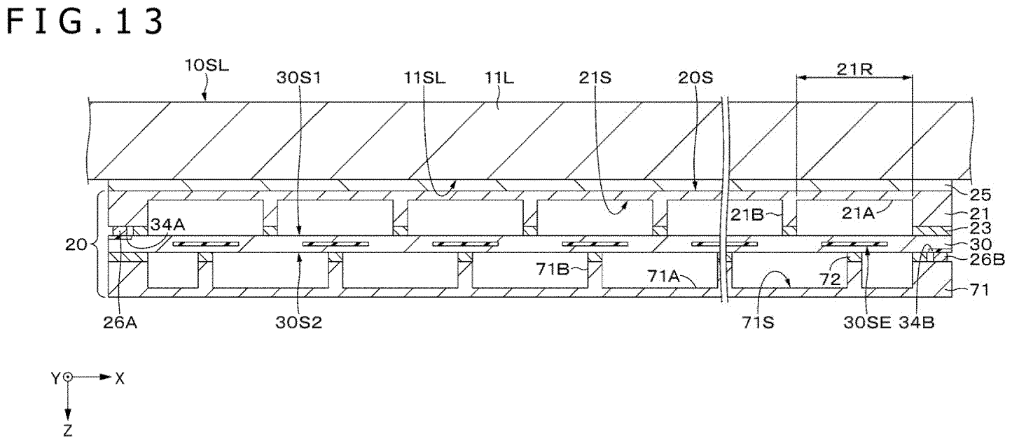

As depicted in FIG. 13, the sensor 20 may include a metal layer 71 facing the second main surface 30S2 of the sensor layer 30, in place of the conductive layer 22. In this case, as the sensor layer 30, a flexible one is used.

The metal layer 71 has a projected and recessed surface 71S facing the second main surface 30S2 of the sensor layer 30. Projected portions 71B of the projected and recessed surface 71S are provided correspondingly to the sensing sections 30SE, whereas recessed portions 71A of the projected and recessed surface 71S are provided correspondingly to positions between the adjacent sensing sections 30SE. Specifically, the projected portions 71B of the projected and recessed surface 71S are provided so as to overlap with the center positions of the sensing sections 30SE in the thickness direction of the sensor 20 (Z-axis direction), whereas the recessed portions 71A of the projected and recessed surface 21S are provided such that the intermediate positions between the adjacent sensing sections 30SE and the center positions of the recessed portions 71A overlap with each other in the thickness direction of the sensor 20 (Z-axis direction). Tips of the projected portions 71B and the sensor layer 30 are adhered to each other by adhesive layers 72, respectively. The configuration of the metal layer 71 is similar to that of the metal layer 21 in the first embodiment, except for the above-mentioned points.

In the sensor 20 having the aforementioned configuration, when the sensing surface 20S is pressed, the region 21R of the metal layer 21 (or the bottom of the recessed portion 21A) is bent toward the sensor layer 30. In addition, a part between the adjacent sensing sections 30SE, of the sensor layer 30, is pressed downward by the projected portion 21B, and a part at the center of the sensing section 30SE, of the sensor layer 30, is pressed upward by the projected portion 71B. As a result, the region 21R of the metal layer 21 and the sensing section 30SE approach each other, and part of an electric line of force between the sub-electrodes 32B and 33B flows into the region 21R of the metal layer 21, resulting in a change in the capacitance of the sensing section 30SE.

### Modification 5

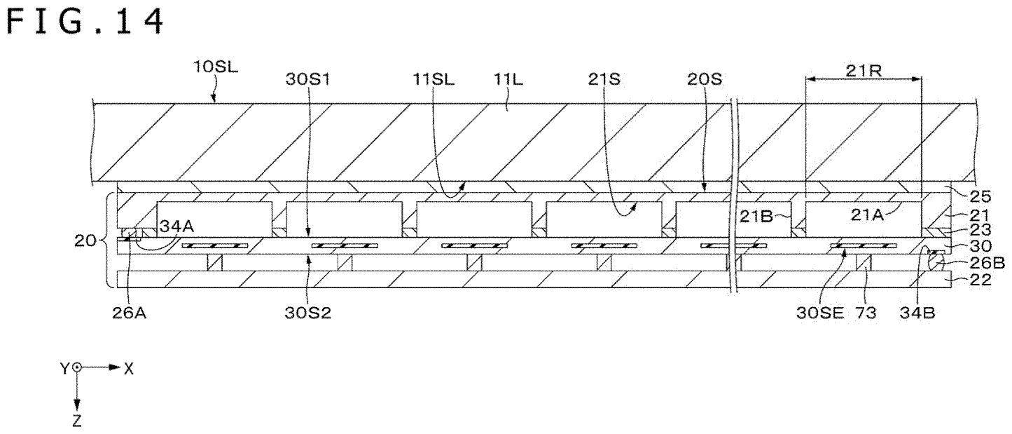

As depicted in FIG. 14, a plurality of columnar bodies 73 may be provided between the sensor layer 30 and the conductive layer 22. The columnar bodies 73 are provided correspondingly to the sensing sections 30SE. Specifically, the columnar bodies 73 are provided so as to overlap with the center positions of the sensing sections 30SE, in the thickness direction of the sensor 20 (Z-axis direction). The shape of the columnar bodies 73 may be similar to that of the projected portions 21B, and may be a truncated cone or pyramid, a cube, a hemisphere or the like. As the material of the columnar bodies 73, a resin material having a pressure sensitive adhesive property is used.

### Modification 6

The sensor 20 may include a conductive base material in place of the conductive layer 22. The electrode base material includes a base material, and a conductive layer provided on a main surface on one side of the base material. The base material is plate-like or film-like in shape. As a material for the base material, there can be mentioned polymer resins which are the same or similar to those for the base material 31 in the first embodiment. The conductive layer is a so-called grounding electrode, which is at a ground potential. Examples of the shape of the conductive layer include a thin film-like shape, a foil-like shape and a mesh-like shape, which are not limitative. As a material for the conductive layer, there can be mentioned materials which are the same or similar to those for the conductive layer 22 in the first embodiment.

### Modification 7

While a configuration in which the sensor 20 includes the conductive layer 22 has been described in the first embodiment, the sensor 20 may not include the conductive layer 22. It is to be noted, however, that it is preferable that the sensor 20 includes the conductive layer 22, for restraining external noises (external electric fields) from penetrating into the inside of the sensor 20 from the back side, or for restraining a lowering in detection accuracy of the sensor 20 or erroneous detection from occurring due to external noises.

### Modification 8

While a configuration in which the electronic apparatus 10 has the sensors 20, 20 respectively at the inside surfaces 11SR and 11SL of the side wall sections 11R and 11L of the housing 11 has been described in the first embodiment, the electronic apparatus 10 may have one loop-formed sensor 20 over the whole part of the inside surface of the wall section 11B, or the electronic apparatus 10 may have a plurality of sensors 20 arranged over the whole part of the inside surface of the wall section 11B. In addition, the sensor 20 may be provided at the inside surface of the main surface section 11A of the housing 11, or the sensor 20 may be provided at the inside surface of the front panel 12.

### Modification 9

While a configuration in which the pulse electrode 32 and the sense electrode 33 are provided at the same surface of the base material 31 has been described in the first embodiment above, a configuration may be adopted in which the pulse electrode 32 is provided at a surface on one side of the base material 31, and the sense electrode is provided at a surface on the other side. In this case, the unit electrode bodies 32A and 33A may have a shape other than the comb tooth-like shape, for example, a mesh-like shape, a concentric shape, a spiral shape or the like.

### Modification 10

While a configuration in which the base material 31 is a flexible substrate or film has been described in the first embodiment, the base material 31 is not limited to this. For example, the base material 31 may be a rigid substrate or a rigid flexible substrate. Examples of the rigid substrate include a paper-phenol substrate, a paper-epoxy substrate, a glass composite substrate, a glass-epoxy substrate, a Teflon substrate, an alumina (ceramic) substrate, a low temperature co-fired ceramic (LTCC) substrate, a composite substrate, and a halogen-free substrate, which are not limitative. In addition, the base material 31 may be a single-faced substrate or may be a double-faced substrate. Besides, the base material 31 is not limited to a monolayer substrate, but may be a multilayer substrate or a build-up substrate.

### Modification 11

While a case where the electronic apparatus is a smartphone has been described as an example in the first embodiment above, the present technology is not limited to this, and the present technology is applicable to various electronic apparatuses having an armor such as a housing. For example, the present technology is applicable to personal computers, mobile phones other than smartphones, television sets, remote controllers, cameras, game apparatuses, navigation systems, electronic books, electronic dictionaries, portable music players, wearable terminals such as smart watches and head-mounted displays, radios, stereos, medical apparatuses, and robots.

### Modification 12

The present technology is applicable not only to electronic apparatuses but also to various things other than electronic apparatuses. For example, the present technology is applicable to electric apparatuses such as electric tool, refrigerators, air conditioners, water heaters, microwave ovens, dish washers, laundry machines, driers, illumination apparatuses, and toys. Further, the present technology is applicable also to buildings such as houses, building components, conveyances for transporting, furniture such as tables and desks, manufacturing devices, and analyzers. Examples of the building components include flagstones, wall materials, floor tiles, and floor boards. Examples of the conveyances for transporting include vehicles (e.g., automobiles, two-wheeled motor vehicles), ships and boats, submarines, trains, airplanes, spacecrafts, elevators, and playthings. Besides, the present technology is applicable also to input devices such as a one-point button and a linear slider.

### 2 Second Embodiment

### Configuration of Input Device

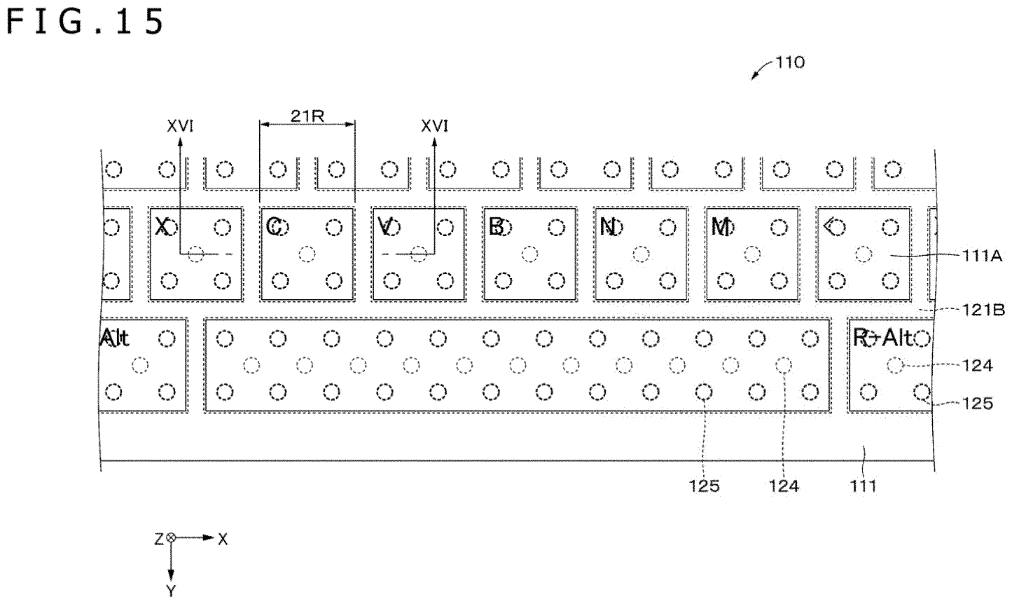

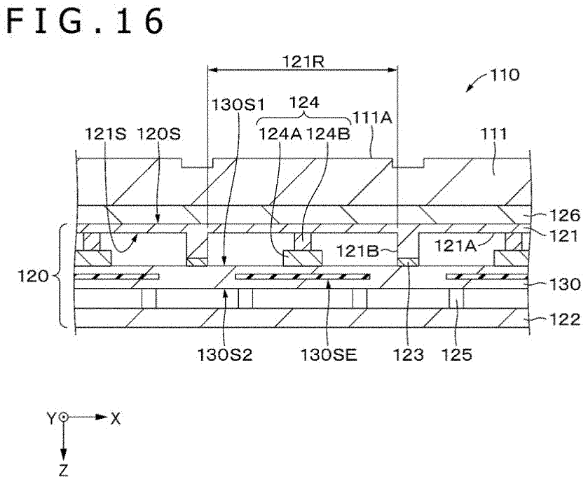

As illustrated in FIGS. 15 and 16, an input device 110 according to a second embodiment of the present technology is a thin type keyboard, which includes a keytop layer 111 as an input section, a sensor 120 provided at an inside surface of the keytop layer 111, and a controller IC (not illustrated) as a control section. Note that the input section is an example of an armor. The keytop layer 111 and the sensor 120 are adhered to each other by an adhesive layer 126. The input device 110 is connected to a host apparatus (not illustrated) such as a personal computer.

(Keytop Layer)

The keytop layer 111 is flexible. As the keytop layer 111, there can be used, for example, a resin film or a flexible metallic plate. A plurality of keys 111A is arranged on a surface of the keytop layer 111 (a surface on the side opposite to the sensor 120). The keys 111A are projected portions projected from the surface of the keytop layer 111, and characters or symbols or the like are printed on upper surfaces of the projected portions. When the key 111A is pressed, information such as a scan code is outputted from the controller IC (not illustrated) to the host.

(Controller IC)

The controller IC determines whether or not an input operation (pressing operation) has been applied to the key 111A, based on an electrical signal which is supplied from the sensor 120 and which accords to a change in capacitance, and outputs information according to the determination result to the host. Specifically, the controller IC determines whether or not the change in capacitance has exceeded a prescribed threshold, and, if it is determined that the change has exceeded the prescribed threshold, the controller IC outputs information concerning the key 111A such as a scan code to the host.

(Sensor)

The sensor 120 is flexible. Specifically, the sensor 120 is a rectangular film, and a main surface on one side of the sensor 120 is a sensing surface 120S for detection of pressing. The sensing surface 120S of the sensor 120 is adhered to the keytop layer 111 through an adhesive layer 126.

As depicted in FIG. 16, the sensor 120 includes: a mutual capacitive sensor layer 130 having a first main surface 130S1 and a second main surface 130S2 and including a plurality of capacitive sensing sections 130SE; a metal layer 121 facing the first main surface 130S1 of the sensor layer 130; a conductive layer 122 facing the second main surface 30S2 of the sensor layer 130; a plurality of columnar bodies 124 provided between the sensor layer 130 and the metal layer 121; and a plurality of columnar bodies 125 provided between the sensor layer 130 and the conductive layer 122. The plurality of sensing sections 130SE is provided correspondingly to the arrangement of the keys 111A in the keytop layer 111.

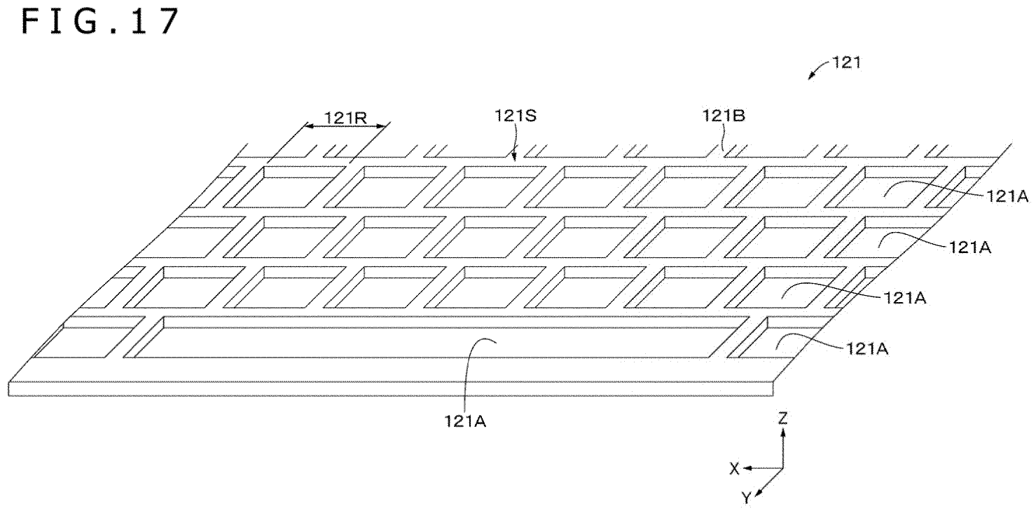

The metal layer 121 has projected portions 121B provided at peripheral edges of regions 121R facing the sensing sections 130SE. Specifically, as depicted in FIG. 17, the metal layer 121 has a projected and recessed surface 121S facing the first main surface 130S1 of the sensor layer 130, the projected and recessed surface 121S has a plurality of recessed portions 121A two-dimensionally disposed in the in-plane directions of the sensing surface 120S, and the recessed portions 121A are each surrounded by the projected portions 121B and are hollows. The recessed portions 121A are provided correspondingly to the keys 111A and the sensing sections 130SE. Specifically, the recessed portions 121A are provided so as to overlap with the keys 111A and the sensing sections 130SE, in the thickness direction of the sensor 120 (Z-axis direction).

The metal layer 121 and the sensor layer 130 are disposed such that main surfaces of the metal layer 121 and the sensor layer 130 face each other. Tips of the projected portions 121B of the metal layer 121 and the sensor layer 130 are adhered to each other through adhesive layers 123, respectively. Columnar bodies 124 are provided in the centers of the recessed portions 121A, and bottoms of the recessed portions 121A (the regions 121R of the metal layer 121) are supported by the columnar bodies 124.

The conductive layer 122 and the sensor layer 130 are disposed such that main surfaces of the conductive layer 122 and the sensor layer 130 face each other. A plurality of columnar bodies 125 is provided between the main surfaces of the conductive layer 122 and the sensor layer 130, and the main surfaces of the conductive layer 122 and the sensor layer 130 are adhered to each other such that the distance between the main surfaces is kept constant by the columnar bodies 125. The plurality of columnar bodies 125 is provided at positions between the columnar bodies 124 and the projected portions 121B in the in-plane directions of the sensing surface 120S.

The columnar bodies 124 support the metal layer 121 in the regions 121R (namely, at bottom surfaces of the recessed portions 121A). The columnar body 124 includes a base 124A and a joint section 124B. The base 124A is in the shape of, for example, a truncated cone or pyramid, a cube, a hemisphere or the like. The joint section 124B is provided on the base 124A, and the base 124 and the metal layer 121 are adhered to each other through the joint section 124B. As the material of the base 124A, there is used, for example, an insulating resin material. As such a resin material, there can be used, for example, a photo-curing resin such as a UV-curing resin. As the material of the joint section 124B, there is used, for example, a pressure sensitive adhesive resin material or the like.

Note that the configuration of the columnar body 124 is not limited to the aforementioned configuration in which the base 124A and the joint section 124B are separate bodies, and a configuration may be adopted in which the base 124A and the joint section 124B are preliminarily integrally molded. In this case, as the material of the columnar bodies 124, a material capable of realizing both of the functions of the base 124A and the joint section 124B is preferably selected.

As the material of the columnar bodies 125, there is used, for example, a resin material which has a pressure sensitive adhesive property and an insulating property.

The plurality of sensing sections 130SE is two-dimensionally disposed in the in-plane directions of the sensing surface 120S. The configuration of the sensing sections 130SE is similar to that of the sensing sections 30SE in the first embodiment.

### Operation of Input Device

An operation of the input device 110 according to the second embodiment of the present technology will be described below. When the key 111A is pressed, the region 121R (namely, the bottom of the recessed portion 121A) of the metal layer 121 located beneath the key 111A is bent toward the sensor layer 130. In addition, that part of the sensor layer 140 which is between the adjacent sensing sections 130SE is pressed down by the projected portion 121B, and that part of the sensor layer 130 which corresponds to the sensing section 130SE is pressed upward by the columnar bodies 125, 125. As a result, the region 121R of the metal layer 121 and the sensing section 130SE approach each other, resulting in a change in the capacitance of the sensing section 130SE. Based on the change in the capacitance, the controller IC (not illustrated) detects the pressing of the key 111A, and outputs the detection result (for example, information about the key, such as a scan code) to the host.

### Effect

In the input device 110 according to the second embodiment, the regions 121R (namely, the recessed portions 121A) are partitioned from each other by the projected portion 121B of the metal layer 121 that is high in rigidity. Therefore, deformation of the metal layer 121 when the key 111A is pressed can be separated on a key 111A basis. Accordingly, when the key 111A is pressed, detection of the change in capacitance by the sensing section 130SE corresponding to the adjacent key 111A can be restrained. In other words, detection accuracy of the input device 110 can be enhanced.

### Modifications

### Modification 1

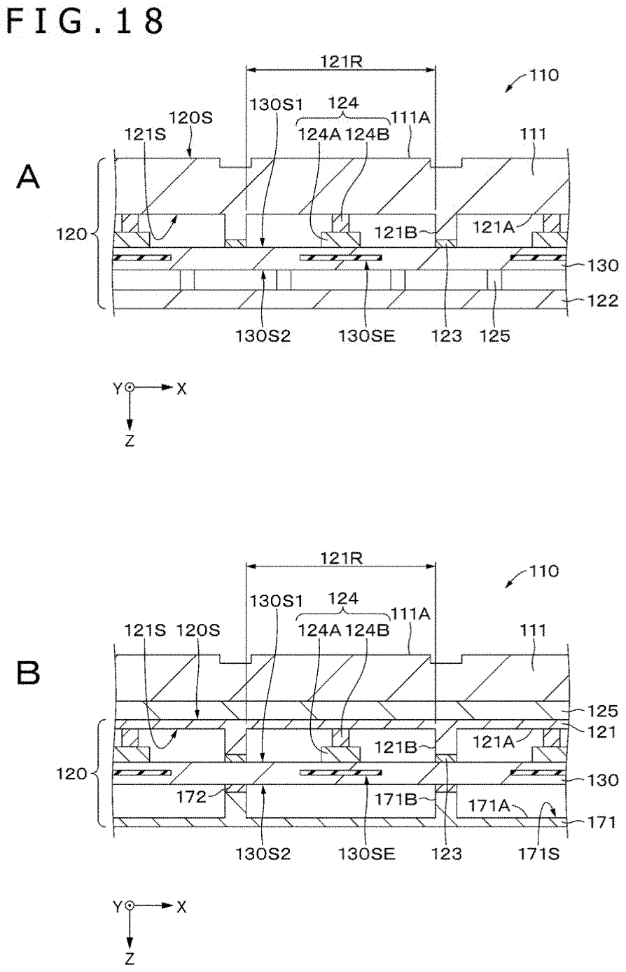

As illustrated in FIG. 18A, the sensor 120 may include a keytop layer 111 configured using a metal, in place of the metal layer 121, and the back surface of the keytop layer 111 may be a projected and recessed surface similar to the projected and recessed surface 121S of the metal layer 121. In this case, the projected and recessed surface is preferably formed by subjecting the back surface of the keytop layer 111 to projection/recess processing such as etching.

### Modification 2

As depicted in FIG. 18B, the sensor 120 may include a metal layer 171 having a projected and recessed surface 171S facing the second main surface 130S2 of the sensor layer 130, in place of the conductive layer 122. In this case, as the sensor layer 130, a flexible one is used.

The recessed portions 171A of the projected and recessed surface 171S are provided correspondingly to the sensing sections 130SE, and the projected portions 171B of the projected and recessed surface 71S are provided correspondingly to positions between the sensing sections 130SE. Specifically, the recessed portions 171A of the projected and recessed surface 171S are provided such that the sensing sections 130SE and the center positions of the recessed portions 171A overlap with each other in the thickness direction of the sensor 120 (Z-axis direction), and the projected portions 171B of the projected and recessed surface 21S are provided so as to overlap with intermediate position between the sensing sections 130SE in the thickness direction of the sensor 120 (Z-axis direction). Tips of the projected portions 171B and the sensor layer 130 are adhered to each other through adhesive layers 172, respectively.

### Modification 3

While a configuration in which the sensor 120 includes the plurality of columnar bodies 125 between the sensor layer 130 and the conductive layer 122 has been described in the first embodiment, the sensor 120 may not include the plurality of columnar bodies 125. In this case, the sensor layer 130 and the metal layer 121 are adhered to each other by an adhesive layer. It is to be noted, however, that it is preferable for the sensor 120 to include the plurality of columnar bodies 125, from the viewpoint of adjusting the detection sensitivity with respect to pressing of the key 111A.

### 3 Third Embodiment

### Configuration of Electronic Apparatus

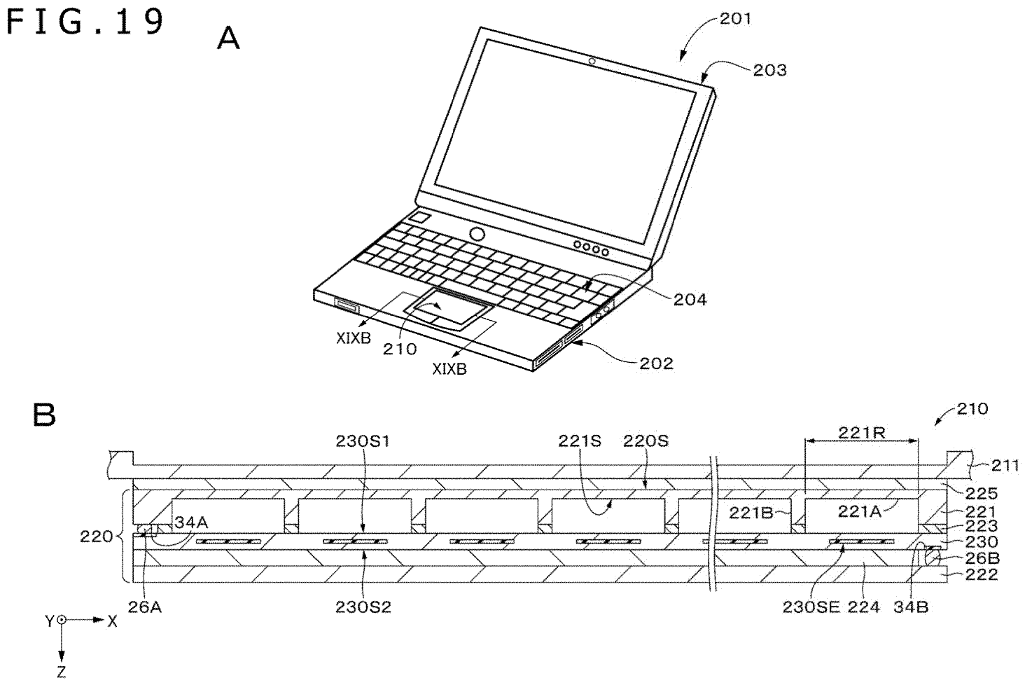

As depicted in FIG. 19A, an electronic apparatus 201 according to a third embodiment of the present technology is a so-called notebook personal computer, which includes a computer main body 202, and a display 203. The computer main body 202 includes a keyboard 204, and a touch pad 210 as an input device.

(Touch Pad)

As illustrated in FIG. 19B, the touch pad 210 includes a sensor 220, and a sheet-shaped armor 211. The sensor 220 and the armor 211 are adhered to each other through an adhesive layer 225. The armor 211 is, for example, a resin sheet or artificial leather.

As depicted in FIG. 19B, the sensor 220 has a first main surface 230S1 and a second main surface 230S2, and includes a mutual capacitive sensor layer 230 including a plurality of capacitive sensing sections 230SE, a metal layer 221 facing the first main surface 230S1 of the sensor layer 230, and a conductive layer 222 facing the second main surface 230S2 of the sensor layer 230.

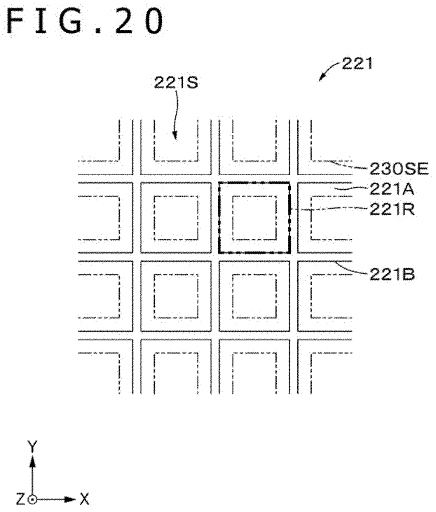

The metal layer 221 has projected portions 221B provided at peripheral edges of regions 221R facing the sensing sections 230SE. Specifically, the metal layer 221 has a projected and recessed surface 221S facing the first main surface 230S1 of the sensor layer 230. The projected and recessed surface 221S has a plurality of recessed portions 221A two-dimensionally disposed in the in-plane directions (X and Y-axis directions) of the sensing surface 220S, and the recessed portions 221A are each surrounded by projected portions 221B on four sides and are hollows. In plan view of the projected and recessed surface 221S in the direction perpendicular to the projected and recessed surface 221S (Z-axis direction), the projected portions 221B are in the form of a matrix, as depicted in FIG. 20. The recessed portions 221A are provided correspondingly to the sensing sections 230SE. Specifically, the recessed portions 221A are provided such that the sensing sections 230SE and the center positions of the recessed portions 221A overlap with each other in the thickness direction of the sensor 220 (Z-axis direction).

The metal layer 221 and the sensor layer 230 are disposed such that main surfaces of the metal layer 221 and the sensor layer 230 face each other. Tips of the projected portions 221B of the metal layer 221 and the sensor layer 230 are adhered to each other through adhesive layers 223, respectively.

The conductive layer 222 and the sensor layer 230 are disposed such that main surfaces of the conductive layer 222 and the sensor layer 230 face each other. The main surfaces of the conductive layer 222 and the sensor layer 230 are adhered to each other by an adhesive layer 224.

The plurality of sensing sections 230SE is two-dimensionally disposed in the in-plane directions (X and Y-axis directions) of the sensing surface 220S. The configuration of the sensing sections 230SE is the same as that of the sensing sections 30SE in the first embodiment.

### Effect

The electronic apparatus 201 according to the third embodiment includes the touch pad 210 as an input device. In this touch pad 210, the regions 221R (namely, the recessed portions 221A) are partitioned from each other by the projected portion 221B of the metal layer 221 that is high in rigidity. Therefore, deformation of the metal layer 221 when the touch pad 210 is pressed can be separated on a region 221R basis. Accordingly, detection accuracy of the touch pad 210 can be enhanced.

### Modifications

### Modification 1

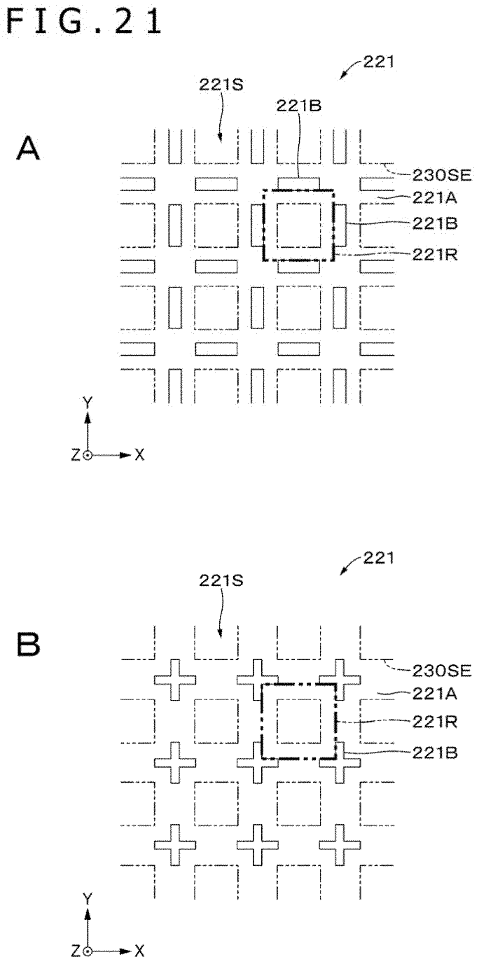

The projected portions 221B may be provided discontinuously around the regions 221R. Specifically, the adjacent regions 221R are not completely divided from each other by the projected portion 221B, and the adjacent regions 221R may be partly connected with each other. In this case, for example, as depicted in FIG. 21A, the projected portions 221B may be provided correspondingly to a position between the sensing sections 230SE adjacent to each other in the X-axis direction (first direction), and may be provided corresponding to a position between the sensing sections 230SE adjacent to each other in the Y-axis direction (second direction). Specifically, the projected portions 221B may be provided so as to overlap with an intermediate position between the sensing sections 230SE adjacent to each other in the X-axis direction (first direction) in the thickness direction of the sensor 220, and may be provided so as to overlap with an intermediate position between the sensing sections 230SE adjacent to each other in the Y-axis direction (second direction) in the thickness direction of the sensor 220.

In addition, as illustrated in FIG. 21B, the projected portions 221B may be provided at positions between the sensing sections 230SE adjacent to each other in an oblique direction. Specifically, the projected portions 221B may be provided so as to overlap with intermediate positions between the sensing sections 230SE adjacent to each other in the oblique direction, in the thickness direction of the sensor 220.

### Modification 2

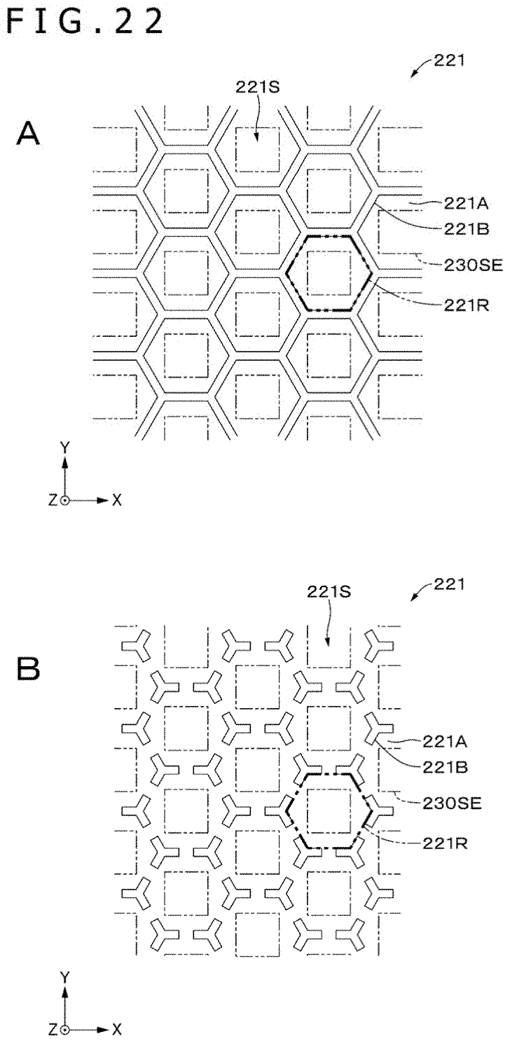

As depicted in FIG. 22A, in plan view of the projected and recessed surface 221S as viewed in the direction perpendicular to the projected and recessed surface 221S (Z-axis direction), the projected portions 221B may be honeycomb-shaped. In this case, as illustrated in FIG. 22B, the projected portions 221B provided in the honeycomb shape may be partly lacking, and the adjacent regions 221R may be connected to each other.

### Modification 3

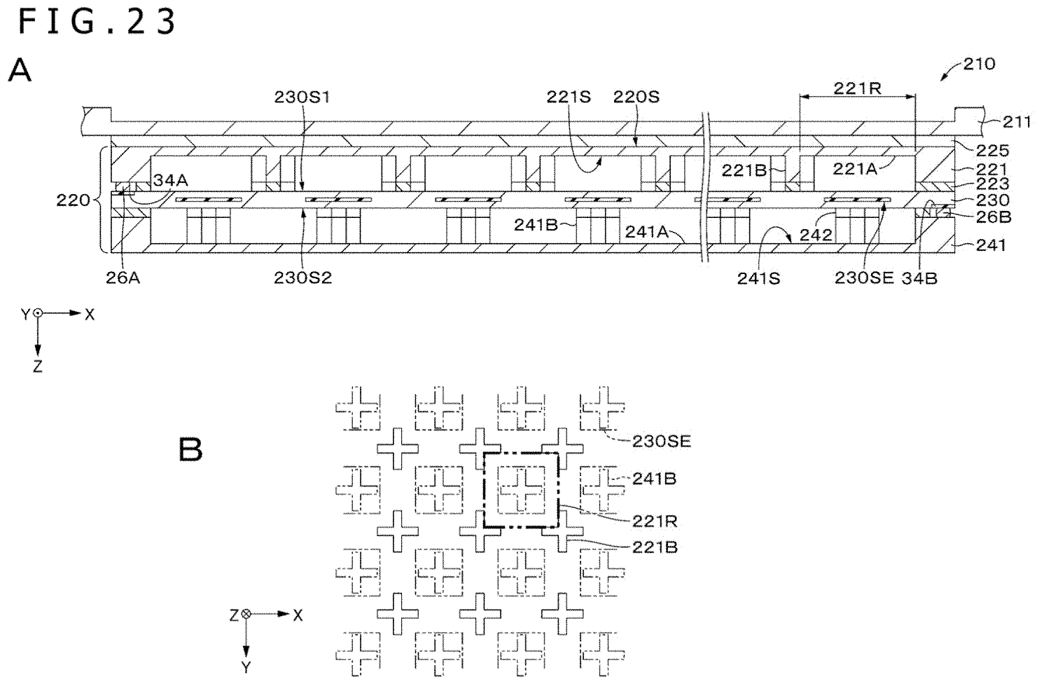

As illustrated in FIG. 23A, the sensor 220 may include a metal layer 241 in place of the conductive layer 222. In the case of adopting this configuration, as the sensor layer 230, a flexible one is used.

The metal layer 241 has a projected and recessed surface 241S facing the second main surface 230S2 of the sensor layer 230. As depicted in FIG. 23B, projected portions 241B of the projected and recessed surface 241S are provided correspondingly to the sensing sections 30SE. Specifically, the projected portions 241B of the projected and recessed surface 241S are provided so as to overlap with the center positions of the sensing sections 230SE in the thickness direction of the sensor 220 (Z-axis direction). Tips of the projected portions 241B and the sensor layer 230 are adhered to each other by adhesive layers 242, respectively.

As depicted in FIG. 23B, the projected portions 221B are provided correspondingly to positions between the sensing sections 230SE adjacent to each other in an oblique direction. Specifically, the projected portions 221B are provided so as to overlap with intermediate positions between the sensing sections 230SE adjacent to each other in the oblique direction, in the thickness direction of the sensor 220.

### 4 Fourth Embodiment

### Configuration of Electronic Apparatus

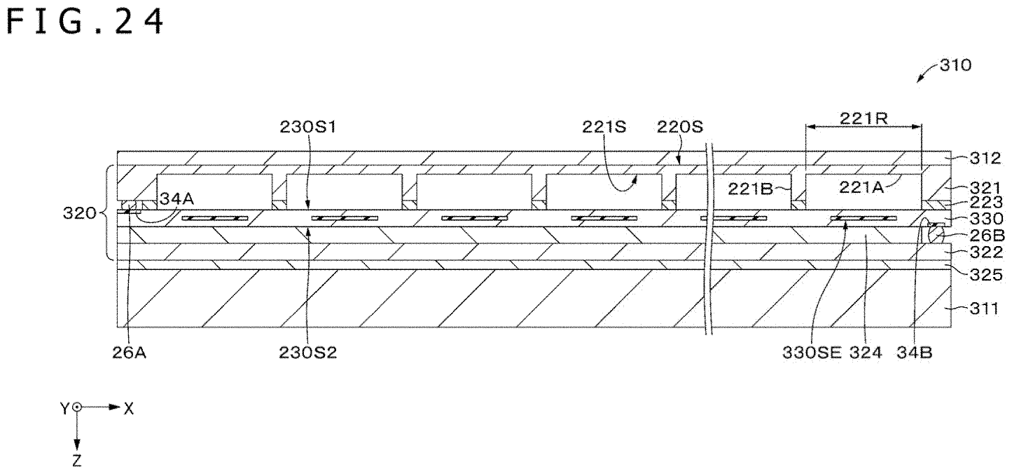

As illustrated in FIG. 24, an electronic apparatus 310 according to a fourth embodiment of the present technology is a so-called tough panel display, which includes a display 311, and a touch panel 320 as a capacitive pressure sensor. The display 311 and the touch panel 320 are adhered to each other by an adhesive layer 325.

The electronic apparatus 310 may further include a protective layer 312 provided at a surface of the touch panel 320, as required. The protective layer 312 may be a polymer resin film, or may be a coating layer such as a hard coat layer.

Examples of the display 311 include, for example, a liquid crystal display and an EL (Electro Luminescence) display, which are not limitative.

The touch panel 320 is transparent to visible rays. The touch panel 320 includes a mutual capacitive sensor layer 330 including a plurality of capacitive sensing sections 330SE, a metallic oxide layer 321 facing a first main surface 230S1 of the sensor layer 330, and a transparent conductive layer 322 facing a second main surface 230S2 of the sensor layer 330. Note that in the fourth embodiment, the parts which are the same or similar to those in the third embodiment above are denoted by the same reference signs as used above, and their descriptions will be omitted.

The metallic oxide layer 321 includes a metallic oxide which is transparent to visible rays. The metallic oxide includes one selected from among, for example, indium tin oxide (ITO), zinc oxide, indium oxide, antimony-added tin oxide, fluorine-added tin oxide, aluminum-added zinc oxide, gallium-added zinc oxide, silicon-added zinc oxide, zinc oxide-tin oxide-based material, indium oxide-tin oxide-based material, zinc oxide-indium oxide-magnesium oxide-based material, and the like.

The sensor layer 330 is the same or similar to the sensor layer 230 in the third embodiment. It is to be noted, however, that as the material of a member constituting the sensor layer 330, a transparent one is used.

The transparent conductive layer 322 includes at least one selected from among, for example, a metallic oxide material, a metallic material, a carbon material, and a conductive polymer. The metallic oxide material includes at least one selected from among, for example, indium tin oxide (ITO), zinc oxide, indium oxide, antimony-added tin oxide, fluorine-added tin oxide, aluminum-added zinc oxide, gallium-added zinc oxide, silicon-added zinc oxide, zinc oxide-tin oxide-based material, indium oxide-tin oxide-based material, and zinc oxide-indium oxide-magnesium oxide-based material. The metallic material includes at least one selected from among, for example, metallic nanoparticles and metallic wire. The carbon material includes at least one selected from among, for example, carbon black, carbon fiber, fullerene, graphene, carbon nanotube, carbon microcoil, and nanohorn. The conductive polymer includes at least one selected from among, for example, substituted or unsubstituted polyaniline, polypyrrole, polythiophene, and (co)polymers containing one or two selected from them.

Note that the sensors 20, 120 and 220 in the first, second and third embodiments may be transparent or non-transparent.

### Effect

The electronic apparatus 310 according to the fourth embodiment includes the touch panel 320. In this touch panel 320, the regions 221R (namely, the recessed portions 221A) are partitioned from each other by the projected portion 221B of the metallic oxide layer 321 which is high in rigidity. Therefore, deformation of the metallic oxide layer 321 when the touch panel 320 is pressed can be separated on a region 221R basis. Accordingly, detection accuracy of the touch panel 320 can be enhanced.

While the embodiments of the present technology and their modifications have been specifically described above, the present technology is not limited to the aforementioned embodiments and modifications, and various modifications based on the technical thought of the present technology are possible.

For instance, the configurations, methods, steps, shapes, materials and numerical values mentioned in the above embodiments and modifications are merely examples, and configurations, methods, steps, shapes, materials and numerical values different from the above-mentioned ones may be used, as required.

In addition, the configurations, methods, steps, shapes, materials and numerical values mentioned in the above embodiments and modifications can be combined together, insofar as the combination does not depart from the gist of the present technology.

Besides, the present technology may adopt the following configurations.

(1)

A sensor including:

a sensor layer that includes a capacitive sensing section; and

a metal layer facing a surface on one side of the sensor layer,

in which the metal layer has a projected portion provided at a peripheral edge of a region facing the sensing section.

(2)

The sensor as described in the above paragraph (1), in which the projected portion is provided so as to divide the adjacent regions.

(3)

The sensor as described in the above paragraph (1) or (2), in which the projected portion is provided so as to surround the region.

(4)

The sensor as described in any one of the above paragraphs (1) to (3),

in which the metal layer has a projected and recessed surface facing the surface on the one side of the sensor layer, and

a recessed portion of the projected and recessed surface is a hollow provided correspondingly to the sensing section.

(5)

The sensor as described in any one of the above paragraphs (1) to (4),

in which that part of the metal layer which corresponds to the region is configured to be deformable toward the sensor layer by pressing of the metal layer, and

the projected portion restricts the deformation of the metal layer to the region.

(6)

The sensor as described in any one of the above paragraphs (1) to (5), further including:

a structure provided on a surface on the other side of the sensor layer, of both surfaces of the metal layer,

in which the structure is provided correspondingly to the sensing section.

(7)

The sensor as described in any one of the above paragraphs (1) to (6), further including:

a columnar body that supports the metal layer in the region.

(8)

The sensor as described in any one of the above paragraphs (1) to (7), further including:

a conductive layer facing the surface on the other side of the sensor layer.

(9)

The sensor as described in the above paragraph (8), further including:

a columnar body provided between the sensor layer and the conductive layer.

(10)

The sensor as described in any one of the above paragraphs (1) to (7), further including:

a metal layer having a projected portion at its surface facing a surface on the other side of the sensor layer.

(11)

The sensor as described in any one of the above paragraphs (1) to (10),

in which the metal layer has an elongate film-like shape,

the sensor layer includes a plurality of the sensing sections, and

the plurality of the sensing sections is disposed in a longitudinal direction of the metal layer.

(12)

The sensor as described in any one of the above paragraphs (1) to (10),

in which the sensor layer includes a plurality of the sensing sections, and

the plurality of the sensing sections is disposed correspondingly to a key arrangement.

(13)

The sensor as described in any one of the above paragraphs (1) to (12),

in which a total thickness of the metal layer is 30 μm to 1 mm, and

the thickness of the metal layer in the region is 10 to 100 μm.

(14)

The sensor as described in any one of the above paragraphs (1) to (13), in which the sensor layer includes a self-capacitive type.

(15)

The sensor as described in any one of the above paragraphs (1) to (13), in which the sensor layer includes a mutual capacitive type.

(16)

An input device including:

an armor; and

a sensor provided at the armor,

in which the sensor includes the sensor as described in any one of the above paragraphs (1) to (15).

(17)

The input device as described in the above paragraph (16), in which the armor has a key provided correspondingly to the sensing section.

(18)

An input device including:

a sensor layer that includes a capacitive sensing section; and

a metal housing facing a surface on one side of the sensor layer,

in which the metal housing has a projected portion provided at a peripheral edge of a region facing the sensing section.

(19)

An electronic apparatus including:

an armor; and

a sensor provided at the armor,

in which the sensor includes the sensor as described in any one of the above paragraphs (1) to (15).

(20)

An electronic apparatus including:

a sensor layer that includes a capacitive sensing section; and

a metal housing facing a surface on one side of the sensor layer,

in which the metal housing has a projected portion provided at a peripheral edge of a region facing the sensing section.

### REFERENCE SIGN LIST

10, 201, 310 . . . Electronic apparatus
10SR, 10SL . . . Side surface
11 . . . Housing
11B . . . Wall section
11M . . . Main surface section
11R, 11L . . . Side wall section
11SR, 11SL . . . Inside surface
11VR . . . Sound volume adjustment region
11CR . . . Camera holding region
11SHR . . . Shutter operation region
12 . . . Front panel
12A, 311 . . . Display
13 . . . Substrate
13A . . . Controller IC
13B . . . CPU
20, 120, 220, 320 . . . Sensor
20S, 120S, 220S . . . Sensing surface
21, 121, 221 . . . Metal layer
21A, 121A, 221A . . . Recessed portion
21B, 121B, 221B . . . Projected portion
21R, 121R, 221R . . . Region
21S, 121S, 221S . . . Projected and recessed surface
22, 122, 222 . . . Conductive layer
23, 24, 25, 72, 123, 126, 172, 223, 224, 225, 242, 325 . . . Adhesive layer
27 . . . Structure
30, 130, 230, 330 . . . Sensor layer
30SE, 130SE, 230SE, 330SE . . . Sensing section
31 . . . Base material
32 . . . Pulse electrode (First electrode)
33 . . . Sense electrode (Second electrode)
40 . . . Flexible printed circuit
73, 124, 125 . . . Columnar body
111 . . . Keytop layer
111A . . . Key
210 . . . Touch pad
211 . . . Armor
320 . . . Touch panel
321 . . . Metallic oxide layer
322 . . . Transparent conductive layer

1. A sensor comprising:
a sensor layer that includes a capacitive sensing section; and
a metal layer facing a surface on one side of the sensor layer,
wherein the metal layer has a projected portion provided at a peripheral edge of a region facing the sensing section.

2. The sensor according to claim 1, wherein the projected portion is provided so as to divide the adjacent regions.

3. The sensor according to claim 1, wherein the projected portion is provided so as to surround the region.

4. The sensor according to claim 1,
wherein the metal layer has a projected and recessed surface facing the surface on the one side of the sensor layer, and
a recessed portion of the projected and recessed surface is a hollow provided correspondingly to the sensing section.

5. The sensor according to claim 1,
wherein that part of the metal layer which corresponds to the region is configured to be deformable toward the sensor layer by pressing of the metal layer, and
the projected portion restricts the deformation of the metal layer to the region.

6. The sensor according to claim 1, further comprising:
a structure provided on a surface on the other side of the sensor layer, of both surfaces of the metal layer,
wherein the structure is provided correspondingly to the sensing section.

7. The sensor according to claim 1, further comprising:
a columnar body that supports the metal layer in the region.

8. The sensor according to claim 1, further comprising:
a conductive layer facing the surface on the other side of the sensor layer.

9. The sensor according to claim 8, further comprising:
a columnar body provided between the sensor layer and the conductive layer.

10. The sensor according to claim 1, further comprising:
a metal layer having a projected portion at its surface facing a surface on the other side of the sensor layer.

11. The sensor according to claim 1,
wherein the metal layer has an elongate film-like shape,
the sensor layer includes a plurality of the sensing sections, and
the plurality of the sensing sections is disposed in a longitudinal direction of the metal layer.

12. The sensor according to claim 1,
wherein the sensor layer includes a plurality of the sensing sections, and
the plurality of the sensing sections is disposed correspondingly to a key arrangement.

13. The sensor according to claim 1,
wherein the total thickness of the metal layer is 30 μm to 1 mm, and
the thickness of the metal layer in the region is 10 to 100 μm.

14. The sensor according to claim 1, wherein the sensor layer includes a self-capacitive type.

15. The sensor according to claim 1, wherein the sensor layer includes a mutual capacitive type.

16. An input device comprising:
an armor; and
a sensor provided at the armor,
wherein the sensor includes the sensor according to claim 1.

17. The input device according to claim 16, wherein the armor has a key provided correspondingly to the sensing section.

18. An input device comprising:
a sensor layer that includes a capacitive sensing section; and
a metal housing facing a surface on one side of the sensor layer,
wherein the metal housing has a projected portion provided at a peripheral edge of a region facing the sensing section.

19. An electronic apparatus comprising:
an armor; and
a sensor provided at the armor,
wherein the sensor includes the sensor according to claim 1.

20. An electronic apparatus comprising:
a sensor layer that includes a capacitive sensing section; and
a metal housing facing a surface on one side of the sensor layer,
wherein the metal housing has a projected portion provided at a peripheral edge of a region facing the sensing section.
